(19) United States
(12) Patent Application Publication
(10) Pub. No.: US 2012/0059735 A1
(43) Pub. Date: Mar. 8, 2012

(54) Product recommendations

(75) Inventors: Ningjun Su, Hangzhou (CN); Zhixiong Yang, Hangzhou (CN); Haijie Gu, Hangzhou (CN); Louhua Zhu, Hangzhou (CN)

(73) Assignee: Alibaba Group Holding Limited

(21) Appl. No.: 13/199,574

(22) Filed: Sep. 1, 2011

(30) Foreign Application Priority Data
Sep. 3, 2010 (CN) 201010273633.1

(51) Int. Cl. G06Q 30/00

(52) U.S. Cl. 705/26.7

(57) ABSTRACT

A technique of product recommendations is disclosed, including: determining user characteristic information and product characteristic information for a user; determining at least one of a basic recommended product set and an auxiliary recommended product set for the user; receiving an indication associated with a type of the user's network operation; generating product recommendations based at least in part on type of the user's network operation and at least one of the basic recommended product set and the auxiliary recommended product set for the user; and presenting the generated product recommendations.

### CROSS REFERENCE TO OTHER APPLICATIONS

This application claims priority to People's Republic of China Patent Application No. 201010273633.1 entitled A PRODUCT INFORMATION RECOMMENDATION METHOD AND SYSTEM filed Sep. 3, 2010 which is incorporated herein by reference for all purposes.

### FIELD OF THE INVENTION

The present disclosure involves data processing technology; in particular, it involves a technique of product information recommendation.

### BACKGROUND OF THE INVENTION

In Internet technology, some websites recommend a variety of product information to users. For example, electronic commerce websites make recommendations to users of products that are available on the websites. The recommendations potentially help users find the products that they want on the website in a more efficient manner.

Generally, when making product recommendations, websites base recommendations on user historical operation data with respect to certain products, such as historical data of the user's product purchases. For example, the websites can use correlation techniques to determine the relationships between one product that is of interest to a user and other products (e.g., that are available on the website). The products that are determined to have relationships with the product of interest are then recommended to the user.

However, such recommendation methods usually only consider the user's historical operation data (or rather, place the most emphasis on the user's historical operation data), and do not comprehensively consider other information associated with the products of interest and so recommendation results are sometimes inaccurate, especially when a user is a new user and has little to no history of operation data.

Moreover, conventional techniques used to determine correlations between a product of interest and other products consume a great amount of system resources. For example, sometimes, for a user, a conventional technique would require that a correlation would need to be determined between a product of interest to the user and every other product available at the website. Such correlations would require a large amount of data to be processed, particularly where there are numerous users and/or products at a website, thereby making the recommendation process inefficient.

### BRIEF DESCRIPTION OF THE DRAWINGS

Various embodiments of the invention are disclosed in the following detailed description and the accompanying drawings.

FIG. 1 is diagram showing an embodiment of system for product recommendations.

FIG. 2 is a flow diagram showing an embodiment of a process of recommending products.

FIG. 3 is a flow diagram showing an embodiment of a process of recommending products.

FIG. 4 is a diagram showing an embodiment of a system for recommending products.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

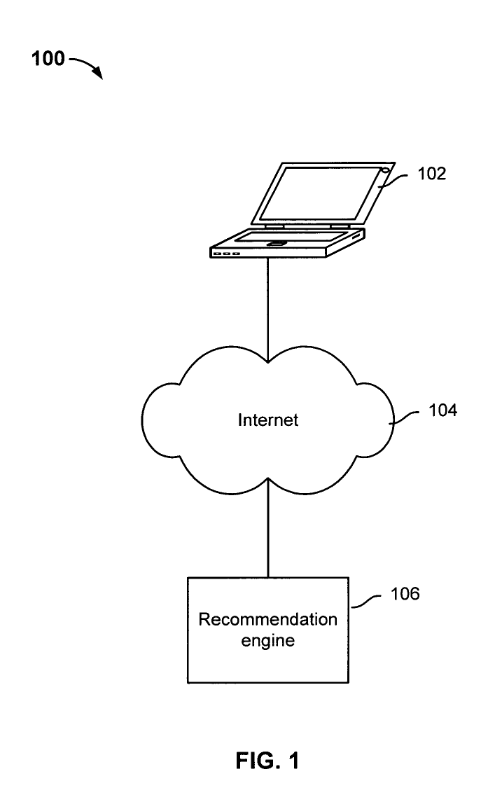

FIG. 1 is diagram showing an embodiment of system for product recommendations. System 100 includes device 102, network 104, and recommendation engine 106. Network 104 can include high-speed data and/or telecommunications networks.

Device 102 is configured to access an electronic commerce website via an application (e.g., a web browser). Examples of device 102 can include a laptop computer, a desktop computer, a tablet device, a smart phone, and any other type of computing device. For example, a user can use device 102 to browse/shop for products that are available at the electronic commerce website. In response to a network operation of the user (e.g., when the user browses a product, purchases a product), the electronic commerce website can present one or more product recommendations to the user.

Recommendation engine 106 is configured to maintain user characteristic information for each user at the electronic commerce website and/or product characteristic information for each product available (e.g., for sale) at the electronic commerce website. Examples of the user characteristic information and product characteristic are described below. In some embodiments, using at least the user characteristic information, recommendation engine 106 determines a user-based basic recommended product set and/or an auxiliary recommended product set for a user. In some embodiments, using at least the product characteristic information, recommendation engine 106 determines a product-based basic recommended product set and/or an auxiliary recommended product set for a user. In various embodiments, recommendation engine 106 generates product recommendations for the user based on a type of network operation associated with the user and/or the user-based basic recommended product set, product-based basic recommended product set, and/or an auxiliary recommended product set.

In some embodiments, recommendation engine 106 is associated with and/or has access to a database storing an inventory of products that are available at the electronic commerce website.

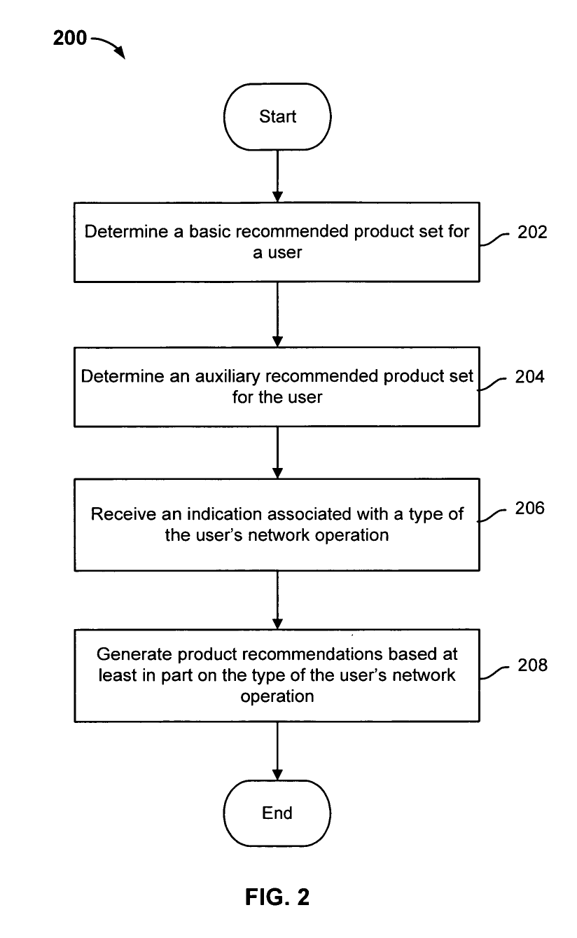

FIG. 2 is a flow diagram showing an embodiment of a process of recommending products. In some embodiments, process 200 can be implemented by recommendation server 106.

At 202, a basic recommended product set for a user is determined for a user.

For example, server 106 is associated with an electronic commerce website and is configured to generate recommendations of products that are available (e.g., for sale) at the website. The electronic commerce website can have many users. A user at the electronic commerce website can be someone who browses/uses the website to potentially purchase one or more products offered at the website. A new user at the electronic commerce website is one for whom the electronic website does not have much historical operation data (e.g., the new user has never purchased and/or browsed any products at the website). In some embodiments, each user has an account (e.g., at least some information associated with the user stored) at the electronic commerce website.

In various embodiments, each of the basic recommended product set and auxiliary recommended product set includes one or more products. In some embodiments, an administrator (e.g., of recommendation engine 106) can determine a size of (e.g., the number of unique products to be included in) a basic recommended product set. In various embodiments, the products of either the basic or auxiliary recommended sets are selected from an inventory of products available at the electronic website.

In various embodiments, there are two types of basic recommended product sets: a user-based basic recommended product set and a product-based basic recommended product set. In various embodiments, for a user, both a user-based recommended product set and a product-based recommended product set are determined. The user-based basic recommended product set is determined using user characteristic information. For example, user characteristic information can include the user's preference information and/or historical access data with respect to products at the electronic website. The user-based basic recommended product set includes a set of recommended products based on the user characteristic information. The product-based basic recommended product set is determined using product characteristic information. For example, product characteristic information includes one or more products that correlate with and/or are relevant to products of interest to the user. The product-based basic recommended product set includes a set of recommended products based on the product characteristic information. In various embodiments, depending on the type of a current user network operation, product recommendations for the user are generated based on either the product-based basic recommended product set or the user-based basic recommended product set. In some embodiments, one or more products included in an auxiliary recommended product set are also recommended to the user in addition to the one or more products of the user-based or product-based basic recommended product sets.

In various embodiments, the products (for either the user-based or product-based types) of the basic recommended product set are limited to those that meet a certain condition. One benefit to limiting the products that can be included within a basic recommended product set is so that the number of products in a set can be reduced in volume and thus save network resources used to access and/or maintain such data. For example, the products selected based on either user characteristic information and/or product characteristic information that are to be included in the basic recommended product sets need to meet one or more of the following conditions: be associated with a predetermined time period (e.g., be made available at the electronic website at a predetermined time period, have been purchased during a predetermined time period), be of a certain numerical threshold (e.g., the threshold can be associated with the number of available items of a certain product), and be associated with at least a threshold number of web page views (e.g., where the web page is at the electronic website and advertises the sale of the product).

At 204, an auxiliary recommended product set is determined for the user.

In various embodiments, the auxiliary recommended product set is determined based on, for example, the user's region and certain products associated with that region (e.g., some of the products that are top-selling in that region).

In some embodiments, the auxiliary recommended product set is used to generate product recommendations for a new user (e.g., when there are no products to be included in a user-based basic recommended product set) and/or for a new product (e.g., when there are no products to be included in a product-based basic recommended product set).

At 206, an indication associated with a type of the user's network operation is received.

In various embodiments, a user's network operation comprises a user interaction at an electronic commerce website. In various embodiments, the type of the user interaction can either relate to a product (e.g., when a user browses with a web page at the electronic commerce website that is associated with a product) or not relate to a particular product (e.g., the user is at the home page of the electronic commerce website).

At 208, product recommendations based at least in part on the type of the user's network operation are generated.

In various embodiments, when the type of the user's network operation relates to a particular product, then product recommendations are generated based at least in part on the product-based basic recommended product set (e.g., determined based on the particular product associated with user network operation) and/or the auxiliary recommended product set. In various embodiments, when the type of the user's network operation does not relate to a particular product, then product recommendations are generated based at least in part on the user-based basic recommended product set and/or the auxiliary recommended product set. Product recommendations include recommendations related to one or more products selected from the appropriate set (e.g., user-based, product-based, auxiliary) product set. In some embodiments, product recommendations are presented to the user as a (e.g., graphical) interactive element at a portion of the electronic commerce website.

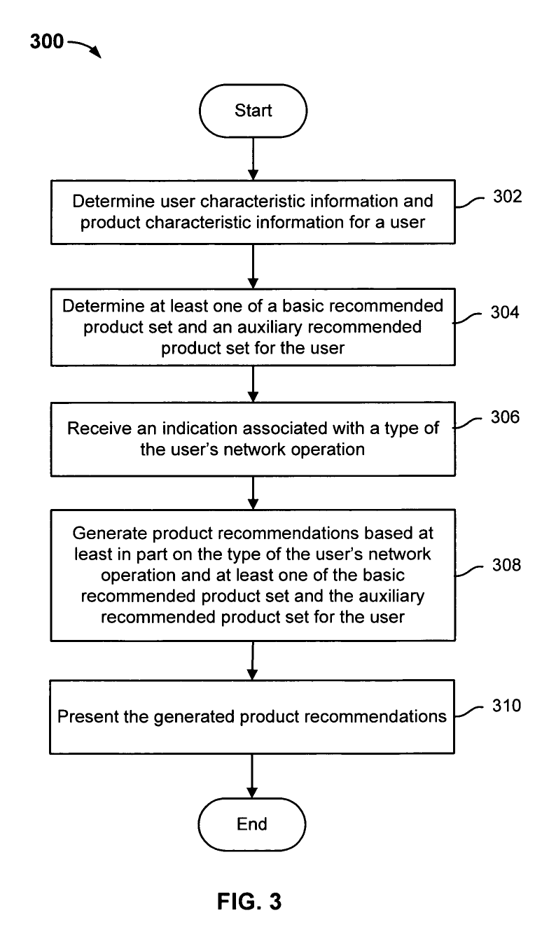

FIG. 3 is a flow diagram showing an embodiment of a process of recommending products. In some embodiments, process 200 can be implemented by recommendation server 106. In some embodiments, process 200 can be implemented by process 300.

At 302, user characteristic information and product characteristic information for a user are determined.

In various embodiments, user characteristic information is determined for each user. In some embodiments, product characteristic information is determined for each product. In some embodiments, interest level information is determined between a user and a product and/or a product and a particular region of origin within a predetermined time period. In some embodiments, user characteristic information, product characteristic information, and/or interest level information is stored in one or more databases.

In some embodiments, user characteristic information includes the region of origin of the user, preferred product subcategories, price range, brand, style, color, material, user activity level, and user credibility. The following are examples of how such user characteristic information can be determined (although, the determination of user characteristic information is not limited to the following): the region of origin of the user can be determined using the IP address of the user; the preferred product subcategories of the user can be determined from the history of product purchases made by the user; the price range of products can be determined based on statistical analysis of products that were previously purchased by the user; the brand, style, color, and material of products predicted can be based on products that were previously purchased by the user; and user activity level/credibility is determined by data mining the user's history of network operations at the electronic commerce website using known techniques.

In some embodiments, product characteristic information for a product includes product subcategories, price, brand, style, color, material, information quality ratings, sales ranking, interest level, and time posted. The following are examples of how such product characteristic information can be determined (although, the determination of product characteristic information is not limited to the following), the product subcategories can be determined from the one or more product subcategories in which the product has been classified by the electronic commerce website, the price of the product can be determined by the price listed for the product at its associated web page at the electronic commerce website; the brand, style, and color of the product can be determined by product specification information maintained by the electronic commerce website; the information quality ratings of the product can be determined by at least feedback given by users (e.g., at a web page associated with the product); the sales ranking of the product can be determined by the electronic commerce website's technique of ranking products based on their respective volume of sales; the interest level of the product (with respect to one or more users) is determined based on various factors with respect to the product; and the time posted of the product is the time at which the product was made available (e.g., for sale) at the electronic commerce website.

In some embodiments, an interest level can be determined with respect to a user and a product and another interest level can be determined with respect to a product and a particular region of origin (e.g., the aggregated interest level between users of the particular region of origin with respect to that product).

In some embodiments, an interest level (between either a user and product or between a product and a particular region of origin) is a value that is determined based on the frequencies of one or more types of user activity at the electronic commerce website such as, for example, searching history associated with the product, selection history associated with the product, feedback history associated with the product, and purchase history associated with the product. In some embodiments, an interest level is determined using user activity during a predetermined period of time (e.g., which could be ten days, a month, etc). One purpose to determining an interest level during a predetermined period of time is to limit the volume of user activities to analyze.

For example, to determine an interest level between user A and product X for the most recent month, the following is first determined: user A has searched for product X five times during the past month, user A has made selections (e.g., of buttons at the web pages) associated with product X three times during the past month, user A has given feedback associated with product X two times during the past month, and user A has purchased product X one time during the past month. Next, a corresponding weight value (e.g., that is predetermined) is attributed to the frequency of each type of user activity and the sum of the weighted frequencies is determined to be the interest level value between the user and the product. Continuing with the same example, assume that respective weight values for the types of user activity of searching history, selection history, feedback history, and purchase history are 1, 3, 9, and 20. Thus, the sum of the weighted frequencies of types of user activities for user A with respect to product X over the most recent month (i.e., the interest level between user A and product X) is 1(5)+3(3)+9(2)+20(1)=52.

In some embodiments, an interest level can be determined between a user and each product with which the user has associated at least one type of user activity. In some embodiments, a predetermined number of products for which a user has the highest interest level values can be determined.

For example, assume that users A, B, and C are from region Q as determined based on the respective IP addresses of the users. In this example, to determine an interest level between product X and region Q (e.g., the aggregated interest level between users A, B, and C of region Q with respect to that product) over a predetermined period, the following can be performed: determine each of users A, B, and C's respective interest level for product X over the predetermined period (e.g., using the technique described above). Next, sum up the individual interest level for product X for users A, B, and C to determine the interest level between product X and region Q over a predetermined period. Assume that the respective individual interest levels for users A, B, and C are 52, 34, and 0, then the interest level between product X and region over the predetermined period is 52+34+0=86.

In some embodiments, an interest level can be determined between each product and a region with which a user of that region has associated at least one type of user activity for that product. In some embodiments, a predetermined number of products that has the highest interest level values associated with a certain region can be determined.

At 304, at least one of a basic recommended product set and an auxiliary product set for the user are determined.

As mentioned above, in some embodiments, there are two types of recommended product sets: user-based and product-based.

In some embodiments, a user-based recommended product set for a user can be determined as follows: the preferred product subcategories are retrieved from the user characteristic information associated the user, the inventory of products available at the electronic commerce website is searched to find those that match the preferred product subcategories, and at least a portion of the matching products are included in a user-based recommended product set for the user.

In some embodiments, a user-based recommended product set for a user can be determined as follows: the preferred product subcategories are retrieved from the user characteristic information associated the user, the inventory of products available at the electronic commerce website is searched to find those that match the preferred product subcategories, interest levels (e.g., associated with a predetermined time period) between the user and one or more products are correlated with other users and their corresponding interest levels for the same one or more products to find other users with interest levels that are highly correlated to that of the user (i.e., these other users are presumed to have similar tastes to those of the user), at least some products that are included in the preferred subcategories for these other users that are highly correlated to the first user are included in the user-based recommended product set.

Correlations between the product interest levels of the user and those of other users can be determined such as in the following example: In this example, the interest levels (e.g., over a predetermined period of time) of various users (users A, B, C, and D) for products are shown in the following table, Table 1:

TABLE 1

| | Interest level | Interest level | Interest level | Interest level |
|---|---|---|---|---|
| | for Product 1 | for Product 2 | for Product 3 | for Product 4 |
| User A | 3 | 1 | 16 | 8 |
| User B | 5 | 0 | 4 | 27 |
| User C | 4 | 7 | 8 | 0 |
| User D | 23 | 13 | 5 | 3 |

The interest levels of User A for Products 1, 2, 3, and 4 can be represented by User_A=(3, 1, 16, 8) and the interest levels of User B for Products 1, 2, 3, and 4 can be represented by User_B=(5, 0, 4, 27). The degree of correlation between Users A and B can be determined using the following formula:

$$sim ( User\_A , User\_B ) = \frac{User\_A \cdot User\_B}{\vert User\_A \vert \times \vert User\_B \vert} \qquad ( 1 )$$

The users with interest levels of products that highly correlate to those of a first user indicate that the users are likely to have similar product preferences as those of the first user. So, products of subcategories preferred by such users are likely to be of interest to the first user.

In some embodiments, the number of products that can be included in a user-based recommended product set can be limited by applying one or more conditions. For example, one condition is that interest levels of products can be determined for a predetermined time period (as mentioned above). In some embodiments, it is determined whether the number of products included in the user-based recommended product set does or does not exceed a predetermined threshold number. If the threshold number is not exceeded, then it is determined that a basic recommended product set is not established for the user. But if the threshold number is exceeded, then it is determined that a basic recommended product set is established for the user. For users for whom basic recommended product sets are not established, product recommendations would be recommended based only on the auxiliary recommended product sets determined for those users.

In some embodiments, an auxiliary recommended product set for a user can be determined as follows: the region of origin of the user is retrieved from the user's characteristic information, the inventory of products that are available at the electronic commerce website is searched for those that are available in that region of origin and/or have relatively high interest levels associated with that region, and of the matching products, a predetermined number of those that are associated with the highest volume of sales and/or highest interest levels in that region or origin and/or the most recent posting times at the electronic commerce website are included in the auxiliary recommended product set for the user. In some embodiments, an auxiliary recommended product set is determined for each product subcategory.

In some embodiments, the auxiliary recommended product sets are established and used so that products can be recommended for new users (for which there is little to no stored user characteristic information determined from, e.g., network operations) or that recommendations can be made for new products (for which there is little to no determined correlations to other products available at the electronic commerce website).

In some embodiments, a product-based recommended product set can include: a basic recommended product set and/or an auxiliary recommended product set.

In some embodiments, a product-based basic recommended product set for a user can be determined by determining correlations between a product that is of interest to the user (e.g., the product is related to a current user network operation, the product was included in a preferred subcategory as indicated in the user characteristic information, the product was recently purchased by the user) and other products available at the electronic commerce website. In some embodiments, a predetermined number of products with high correlations to a product that is of interest to the user is selected to be included in a product-based recommended product set for the user.

Correlations between a product and another product can be determined as shown in the following example: In this example, the interest levels (e.g., over a predetermined period of time) of various users (users A, B, C, and D) for products are shown in the following table, Table 2 which includes the same values of those of Table 1):

TABLE 2

| | Interest level | Interest level | Interest level | Interest level |
|---|---|---|---|---|
| | for Product 1 | for Product 2 | for Product 3 | for Product 4 |
| User A | 3 | 1 | 16 | 8 |
| User B | 5 | 0 | 4 | 27 |
| User C | 4 | 7 | 8 | 0 |
| User D | 23 | 13 | 5 | 3 |

The interest levels of Product 1 for Users A, B, C, and D can be represented by Product_{—}1=(3, 5, 4, 23) and the interest levels of Product 1 for Users A, B, C, and D can be represented by Product_{—}2=(1, 0, 7, 13). The degree of correlation between Products 1 and 2 can be determined using the following formula:

$$sim ( Product\_ 1 , Product\_ 2 ) = \frac{Product\_ 1 \cdot Product\_ 2}{\vert Product\_ 1 \vert \times \vert Product\_ 2 \vert} \qquad ( 2 )$$

In some embodiments, it is determined whether the number of products included in the product-based recommended product set does or does not exceed a predetermined threshold number. If the threshold number is exceeded, then it is determined that a product-based basic recommended product set is established for the user. But if the threshold number is not exceeded, then it is determined that a product-based basic recommended product set is not established for the user. For users for whom basic recommended product sets are not established, product recommendations would be recommended based only on the auxiliary recommended product sets determined for those users. An auxiliary recommended product set can be determined as mentioned above.

At 306, an indication associated with a type of the user's network operation is received.

In various embodiments, a user's network operation comprises a user interaction at an electronic commerce website. For example, the user's network operation can include a user's opening of a web page, a user's browsing of a product's web page, and a selection to purchase a product at that product's web page. In various embodiments, a type of the user interaction can either relate to a product (e.g., when a user browses with a web page at the electronic commerce website that is associated with a product) or not relate to a particular product (e.g., the user is at the home page of the electronic commerce website).

At 308, product recommendations based at least in part on the type of the user's network operation are generated and at least one of the basic recommended product set and the auxiliary recommended product set for the user.

In various embodiments, if the type of the user's network operation does not relate to a product, then the product recommendation type is determined to include user-based product recommendations. For example, a user network operation does not relate to a product when the user is at a home page (which is not associated with any particular product) of the electronic commerce website, or when the user is viewing service agreement/account information, etc.

In various embodiments, if the type of the user's network operation does relate to a product, the product recommendation type is determined to include user-based product recommendations. For example, a user network operation relates to a product when the operation is associated with a user activity with respect to a product (e.g., the purchase of a product, the search for a product, the selection of an element on a web page for the product, giving feedback in association with the product).

When the network operation does not relate to a product, the user-based basic recommended product set, if one has been established, is retrieved. In some embodiments, a predetermined number of products are selected from the retrieved user-based basic recommend product set. In some embodiments, when the actual number of products that is available in the user-based basic recommended product set is less than the predetermined number, then the difference between the actual number of products that is available in the user-based basic recommended product set and the predetermined number is determined. Then the number of products that is equivalent to this difference is selected from the auxiliary recommended product set (if such an auxiliary recommended product set has been established) so that there is a mix of products from the basic recommended product set and the auxiliary recommended product set equal to the predetermined number. The products selected from the user-based basic recommended product set and/or auxiliary recommended product set are ranked. In some embodiments, the selected products are ranked based on a predetermined ranking rule. For example, the ranking rule can be based on the user characteristic information to produce a ranking of products, where those ranked higher are more likely to be of interest to the user than those ranked lower. Specifically, for example, the products can be ranked by price, brand, style, and color that are preferred by the user. Or, for example, the products for which the user with which the user has performed a user activity can be ranked higher (based on the presumption that the user has already shown interest in such products). In some embodiments, a predetermined number of the highest ranked products are used for recommending to the user.

When the network operation does relate to a product, the product-based basic recommended product set (e.g., associated with the product related to the network operation), if one has been established, is retrieved. In some embodiments, a predetermined number of products are selected from the retrieved product-based basic recommended product set. In some embodiments, when the actual number of products that is available in the product-based basic recommended product set is less than the predetermined number, then the difference between the actual number of products that is available in the product -based basic recommended product set and the predetermined number is determined. Then the number of products that is equivalent to this difference is selected from the auxiliary recommended product set associated with the same subcategory as that of the product related to the user's network operation (if such an auxiliary recommended product set has been established) so that there is a mix of products from the basic recommended product set and the auxiliary recommended product set equal to the predetermined number. The products selected from the user-based basic recommended product set and/or auxiliary recommended product set are ranked. In some embodiments, the selected products are ranked based on a predetermined ranking rule. For example, the ranking rule can be based on the product characteristic information to produce a ranking of products, where those ranked higher are more likely to be of interest to the user than those ranked lower. Specifically, for example, the products can be ranked by the degree of correlation that each product has with the product associated with the user's network operation. Or, for example, the products for which the user has performed a user activity can be ranked higher (based on the presumption that the user has already shown interest in such products). In some embodiments, a predetermined number of the highest ranked products are used for recommending to the user.

At 310, the generated product recommendations are presented.

In some embodiments, depending on the type of the recommended product set (either user-based or product-based) from which the recommended products were selected, the products are presented differently (e.g., so that the user can see that the recommendations are determined from either user characteristic information or product characteristic information).

For example, on electronic commerce websites, product recommendations can be made when a user arrives at a web page associated with the confirmation of a product purchase. At the confirmation web page, there could be displayed two product recommendation sections: one that is labeled “Users who purchase this product also bought” and another that is labeled as “Other recommendations of possible interest.” In this example, products that are selected from the user-based basic recommended product set based on the user's characteristic information are displayed in the “Users who purchased this product also bought” section and products that are selected from the product-based basic recommended product set based on the most recently purchased product are displayed in the “Other recommendations of possible interest” section.

In some embodiments, the effectiveness of the product recommendations can be assessed over time. For example, certain metrics for a recommended product such as the length of time a user spends at an associated web page, number of views of the web page, volume of sales, and amount of feedback on the product can be tracked. These metrics can be used to determine an effectiveness of the generated recommendations. Based on the determined effectiveness, a system administrator can decide to tune the parameters of the recommendation engine.

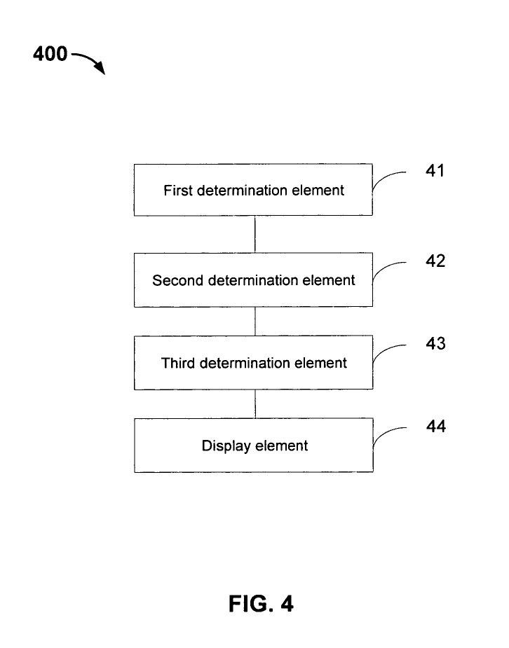

FIG. 4 is a diagram showing an embodiment of a system for recommending products.

The elements, sub-elements, and modules can be implemented as software components executing on one or more processors, as hardware such as programmable logic devices and/or Application Specific Integrated Circuits designed to perform certain functions or a combination thereof. In some embodiments, the elements, sub-elements, and modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The elements, sub-elements, and modules may be implemented on a single device or distributed across multiple devices.

First determination element 41 is configured to determine the user-based recommended product sets for each user (e.g., of the electronic commerce website) and/or the product-based recommended product sets for each product (e.g., in the inventory the electronic commerce website) and/or an auxiliary recommended product set.

Second determination element 42 is configured to receive an indication associated with a user's network operation and determine the product recommendation type based on the type of the user's network operation. In some embodiments, the type of the user network operation could be either related to a product or not related to a product.

Third determination element 43 is configured to determine the product recommendations to be provided to the user based on the corresponding product recommendation type from among the user-based basic recommended product set and/or the product-based basic recommended product set for the product that is associated with the user network operation. In some embodiments, third determination element 43 is configured to also determine one or more products from the auxiliary recommended product set.

In some embodiments, first determination element 41 includes:

A first determination sub-element that is configured to determine the user-based basic recommended product set for each user; and/or,

A second determination sub-element that is configured to determine the product-based basic recommended product set for each product.

In some embodiments, the first determined sub-element includes:

A first determination module that is configured to determine the user characteristic information for each user and the product characteristic information for each product.

A first composition module that is configure to, for each user, retrieve the preferred product subcategories corresponding to the user from the user's characteristic information; to search through the product inventory to find products that match the preferred product subcategories; and to select a predetermined number of products from among the described products found to include in the user-based basic recommended product set.

In some embodiments, the first determination sub-element includes:

A second determination module that is configured to determine the user characteristic information for each user, the product characteristic information for each product, interest level information between products and users and/or regions of origin over a predetermined time period.

A third determination module that is configured to, for each user, retrieve the preferred product subcategories corresponding to the user from the user's characteristic information; to search through the product inventory to find products that match the preferred product subcategories; to correlate the user to other users based on their respective interest level information to one or more products, and to determined the products of interest to users who are found to highly correlate with the first user.

A second composition module that is configured to select a predetermined number of products from among the determined products of interests to users who are found to highly correlate with the first user to include the user's user-based basic recommended product set.

In some embodiments, the second determination sub-element includes:

A fourth determination module that is configured to determine the interest level information for each user over a predetermined period of time and one or more products.

A first computation module that is configured to compute the degree of correlation between different products based on their interest level information associated with one or more users.

A third composition module that is configured to, for each product, select a predetermined number of products with the highest correlation to the product to include in the basic recommended product set for an associated user.

In some embodiments, the first determination sub-element may further include:

A fifth determination module that is configured to determine the user characteristic information for each user and the product characteristic information for each product.

A fourth composition module that is configured to, for each user, determine the user's region of origin from the user's user characteristic information; to search through the product inventory to find products that are top-selling and/or are associated with high interest levels and/or are recently posted at the region of origin to include in the auxiliary recommended product set for the user.

In some embodiments, the second determination sub-element further includes:

A fifth composition module that is configured to determine a predetermined number of products (e.g., of a particular product sub-category) that are associated with the highest interest levels over a predetermined time period to include in the product-based auxiliary recommended product set.

In some embodiments, third determination element 43 includes:

A first retrieval sub-element that is configured to select a predetermined number of products from the user's user-based basic recommended product set; and, when the actual number of products included in the basic recommended product set is less than the predetermined number, to select from the user's auxiliary recommended product set a number of products equal to the difference between the actual number included in the actual basic recommended product set and the predetermined number.

A first selection sub-element that is configured to rank the described predetermined number of products based on a predetermined first rule, and select a predetermined number of the top-ranked products to recommend to the user.

In some embodiments, when the product recommendation type is user-based, the third determination element 43 includes:

A second retrieval sub-element that is configured to select a predetermined number of products from a product-based basic recommended product set (e.g., that is determined based on a product associated with a current user network operation); and, when the actual number of products included in the basic recommended product set is less than the predetermined number, to select from the user's auxiliary recommended product set a number of products equal to the difference between the actual number included in the actual basic recommended product set and the predetermined number.

A second selection sub-element that is configured to rank the selected products to recommend to the user based on a predetermined second rule, and select a predetermined number of the top-ranked products to be recommended to the user.

In some embodiments, system 400 includes:

Display element 44 that is used to display to the user the recommendations of the selected products.

Ordinary persons skilled in the art are able to understand that the process of realizing the method in the aforesaid embodiments can be achieved using hardware associated with programmed commands, and that the described programs can be stored on readable storage media; the corresponding steps contained in the method described above are executed during execution of said programs. The described storage media may include such media as: ROM/RAM, floppy disk, CD, etc.

The description above is only specifically implementing the present disclosure; it should be pointed out that ordinary technical personnel in this field of technology, on the premise of non-departure from the principles of the present disclosure, can also produce a number of improvements and embellishments, and that such improvements and embellishments should also be regarded as within the scope of protection of the present disclosure.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
determine user characteristic information and product characteristic information for a user;
determine a basic recommended product set and an auxiliary recommended product set for the user;
receive an indication associated with a type of the user's network operation;
generate product recommendations based at least in part on type of the user's network operation and at least one of the basic recommended product set and the auxiliary recommended product set for the user; and
present the generated product recommendations; and
a memory coupled with the processor and configured to provide the processor with instructions.

2. The system of claim 1, wherein the user characteristic information includes the region of origin of the user, preferred product subcategories, price range, brand, style, color, material, user activity level, and user credibility.

3. The system of claim 1, wherein the product characteristic information includes product subcategories, price, brand, style, color, material, information quality ratings, sales ranking, interest level, and time posted.

4. The system of claim 1, wherein the auxiliary recommended product set is determined based on a region of origin associated with the user.

5. The system of claim 4, wherein the region of origin associated with the user is determined at least in part on a IP address associated with the user.

6. The system of claim 1, wherein the basic recommended product set comprises one of a user-based basic recommended product set and a product-based basic recommended product set.

7. The system of claim 6, wherein a type of the user's network operation is either related to a product.

8. The system of claim 6, wherein a type of the user's network operation is not related to a product.

9. The system of claim 7, wherein the processor is further configured to generate product recommendations based at least in part on the product-based basic recommended product set.

10. The system of claim 8, wherein the processor is further configured to generate product recommendations based at least in part on the user-based basic recommended product set and/or the auxiliary recommended product set.

11. The system of claim 1, wherein the user's network operation is associated with a user activity at an electronic commerce website.

12. The system of claim 1, wherein the processor is further configured to rank the product recommendations based at least in part on a predetermined rule.

13. A method, comprising:
determining user characteristic information and product characteristic information for a user;
determining at least one of a basic recommended product set and an auxiliary recommended product set for the user;
receiving an indication associated with a type of the user's network operation;
generating product recommendations based at least in part on type of the user's network operation and at least one of the basic recommended product set and the auxiliary recommended product set for the user; and
presenting the generated product recommendations.

14. The method of claim 13, wherein the user characteristic information includes the region of origin of the user, preferred product subcategories, price range, brand, style, color, material, user activity level, and user credibility.

15. The method of claim 13 wherein the product characteristic information includes product subcategories, price, brand, style, color, material, information quality ratings, sales ranking, interest level, and time posted.

16. The method of claim 13, wherein the auxiliary recommended product set is determined based on a region of origin associated with the user.

17. The method of claim 13, wherein the basic recommended product set comprises one of a user-based basic recommended product set and a product-based basic recommended product set.

18. The method of claim 17, wherein a type of the user's network operation is related to a product.

19. The method of claim 17, wherein a type of the user's network operation is not related to a product.

20. The method of claim 18, further comprising generating product recommendations based at least in part on the product-based basic recommended product set and/or the auxiliary recommended product set.

21. The method of claim 19, further comprising generating product recommendations based at least in part on the user-based basic recommended product set and/or the auxiliary recommended product set.

22. The method of claim 13, wherein the user's network operation is associated with a user activity at an electronic commerce website.

23. The method of claim 13, further comprising ranking the product recommendations based at least in part on a predetermined rule.

24. A computer program product, the computer program product being embodied in a computer readable medium and comprising computer instructions for, comprising:
determining user characteristic information and product characteristic information for a user;
determining at least one of a basic recommended product set and an auxiliary recommended product set for the user;
receiving an indication associated with a type of the user's network operation;
generating product recommendations based at least in part on type of the user's network operation and at least one of the basic recommended product set and the auxiliary recommended product set for the user; and
presenting the generated product recommendations.
